(19) United States
(12) Patent Application Publication
(10) Pub. No.: US 2024/0002971 A1
(43) Pub. Date: Jan. 4, 2024

(54) DIRECT LEACHING FROM SULFIDIC REFRACTORY ORES OR CONCENTRATES

(71) Applicants: Arizona Board of Arizona on Behalf of the University of Arizona, Tucson, AZ (US); TCB International LLC, Phoenix, AZ (US)

(72) Inventors: Jaeheon LEE, Tucson, AZ (US); Ken Jewell, Phoenix, AZ (US); David Drye, Phoenix, AZ (US)

(21) Appl. No.: 18/252,344

(22) PCT Filed: Aug. 30, 2021
(86) PCT No.: PCT/US2021/048292

§ 371 Date: May 9, 2023

Related U.S. Application Data
(60) Provisional application No. 63/072,120, filed on Aug. 29, 2020.

(51) Int. Cl. C22B 3/08; C22B 1/24; C22B 11/00; C22B 43/00; C22B 3/42; C22B 3/24

(52) U.S. Cl. CPC C22B 3/08; C22B 1/24; C22B 3/24; C22B 43/00; C22B 3/42; C22B 11/04

(57) ABSTRACT

The present invention relates a method of leaching metals involving the use of thiourea, sodium metabisulfite (SMB), sulfuric acid, and a source of hypochlorite. The method is useful, for example, for leaching metal-containing materials to obtain precious metals (e.g., gold) as well as for purifying base metals (e.g., copper), and for removal of metals from electronic wastes.

### CROSS REFERENCE TO RELATED APPLICATIONS

This application claims the benefit of U.S. Provisional Application No. 63/072,120, filed on Aug. 29, 2020, entitled “Direct Leaching from Sulfidic Refractory Ores or Concentrates”. The entirety of the foregoing is hereby incorporated by reference.

### FIELD OF THE INVENTION

The field of the invention relates generally to extraction of metal from ores and metal-containing materials.

### BACKGROUND

Leaching, for example, precious metals such as gold and silver, and platinum group metals (PGM) (i.e., platinum (Pt), palladium (Pd), rhodium (Rh), iridium (Ir), ruthenium (Ru), and osmium (Os)), from minerals using cyanide has been the industry standard for a long time. Most of the easily leachable oxide minerals can be processed by simple cyanidation. However, as the mineralogy of the ores get more complicated and the precious metals are associated with sulfide such as pyrite and arsenopyrite, the efficiency of the cyanidation is significantly decreased due to the refractory nature of the sulfide. The gold recovery from the sulfide ores or concentrates are generally below 40% which is not an economic way to process the gold containing materials.

The conventional way to increase the gold extraction is the pre-treatment or pre-oxidation of sulfides using autoclave or roaster in higher temperature to break down the sulfur followed by the conventional cyanidation. The capital and operating costs of the pressure oxidation plant using autoclave or roaster plant are very expensive and it is more difficult to get permits to build one these days due to the environmental concerns. There is an urgent need for an environmentally friendly alternative for leaching that is low cost.

This background information is provided for the purpose of making information believed by the applicant to be of possible relevance to the present invention. No admission is necessarily intended, nor should it be construed, that any of the preceding information constitutes prior art against the present invention.

### SUMMARY

One advantage of the methods of the present invention is that pressure oxidation (POX) or roasting plants, which are high energy and therefore expensive processes traditionally used to extract the gold from refractory sulfidic materials may be eliminated. The present invention comprises the use of aqueous thiourea systems with a hypochlorite oxidant to leach metals such as gold with very high yield percentages. Methods of the present invention may be used to leach metals from gold concentrates and primary copper concentrates. Many copper mines have very small amounts of gold in the ore, and it upgrades during the copper concentrating process resulting in higher gold content in the copper concentrates. These concentrates are shipped to smelters and the copper company gets the credit out of it but not in the full value of the precious metal.

Thiourea is a relatively green chemical compared to cyanide which has been used to extract gold in the gold mining industry, and thus it would be much easier to obtain a construction and operation permits in the US and other countries. Due to the toxicity and issues with cyanide in the past, the states of Montana and Wisconsin have banned cyanide leaching. The countries of Turkey, Costa Rica, Czech Republic, Hungary and several provinces of Argentina have also banned the use of cyanide. Germany has banned cyanide leaching at mine sites since 2002 (Laitos, The Current status of Cyanide Regulations, 2012).

Thiourea leaching of gold and silver has a faster kinetics and is up to seven times faster than cyanidation if the materials are properly ground. Most gold silver ores can be leached within about 1.5 to about 2 hours.

The present invention may also be used to leach Platinum Group Metals (PGMs). Times vary for the leaching of PGMs. The average leach time for palladium is 4 to 6 hours. Platinum, Rhodium and other PGMs can be extracted in 6 to 24 hours.

Disposal of tailings from a thiourea leach are much safer than cyanide leached tailings. Thiourea naturally break down fairly quickly when exposed to the environment. Chlorine (a byproduct of the hypochlorite oxidant during the leaching process) also easily breaks down when exposed to light and air.

Thiourea leach as encompassed by the invention is much more effective on the recovery of refractory gold ores and concentrates associated with sulfide minerals including pyrite and other sulfides. Sulfidic refractory gold typically shows less than 40% gold extraction by cyanidation, but this technology can extraction over 95% of gold.

Thiourea leaching method as encompassed by the present invention not only works well on precious metal ores or concentrates but also on platinum group metals and base metal concentrates, and ores.

Thiourea leach as encompassed by the invention may be configured to selectively dissolve precious metals if other base metals co-exist in the materials such as copper. One advantage of the invention is that copper is not leached concurrently with gold as cyanide solution does. This makes thiourea leaching of polymetallic ores or concentrates as encompassed by the invention more economically advantageous than cyanidation due to lower reagent consumption.

One challenge of using thiourea for leaching is monitoring and maintaining the concentrations of sodium metabisulfite (“SMB”) and thiourea. If the concentration is too low, the leaching reaction won't happen well. If it is too high, consumption will be higher with increased cost. This is due to the fact that the high oxidative environment from the hypochlorite can easily oxidize the thiourea to formamidine disulfide, thereby rapidly decreasing the concentration of thiourea without any leaching of metals. The inventors found that by titrating thiourea during the metal recovery process, as disclosed herein, the precise control and management of the thiourea concentration during the leaching precious can be optimized. Furthermore, the inventors developed a simple, easy, and accurate method of thiourea titration, encompassed by the invention, for proper reaction control and reagent management.

One aspect of the present invention pertains to a method of leaching a material, said method comprising:
a) mixing water and sulfuric acid to obtain an aqueous sulfuric acid solution;
b) dissolving thiourea and sodium metabisulfite (“SMB”) in an amount of the sulfuric acid solution of step (a);
c) adding the solution of step (b) to the remaining amount of sulfuric acid solution made in step (a);
d) adding a source of hypochlorite to the solution made in step (c) to obtain a leaching solution;
e) adding said material chosen from an ore, a metal-containing material, and a concentrate, to the solution of step (d) to start the leaching process; and
f) recovering metal (e.g., using an ion exchange resin);

wherein said thiourea in step (b) is titrated prior to addition of the solution of step(b) to step (c).

A further aspect of the present invention pertains to a method of leaching a material, said method comprising:
(i) preparing a solution by premixing and dissolving thiourea and SMB and adding the resulting thiourea/SMB solution to an aqueous sulfuric acid solution;
(ii) adding a source of hypochlorite to the solution made in step (i) to obtain a leaching solution;
(iii) adding said material chosen from an ore, a concentrate, and a metal-containing material, to the solution of step (ii) to start the leaching process; and
(iv) recovering metal (e.g., using an ion exchange resin);

wherein said thiourea in step (i) is titrated prior to addition to the sulfuric acid solution In some embodiments, the thiourea concentration is monitored during step (i).

Another aspect of the present invention pertains to a method of leaching mercury from a mercury-containing material, said method comprising:
a) mixing water and sulfuric acid to obtain an aqueous sulfuric acid solution;
b) dissolving thiourea and sodium metabisulfite in an amount of the solution of step (a);
c) adding the solution of step (b) to the remaining amount of sulfuric acid solution made in step (a);
d) adding a source of hypochlorite to the solution made in step (c) to obtain a leaching solution;
e) adding said mercury containing-material to the solution of step (d) to start the leaching process.
f) recovering mercury using e.g., an ion exchange resin.

A further aspect of the present invention pertains to a method of leaching mercury from a mercury-containing material, said method comprising:
(i) preparing a solution by premixing and dissolving thiourea and SMB and adding the resulting thiourea/SMB solution to an aqueous sulfuric acid solution;
(ii) adding a source of hypochlorite to the solution made in step (i) to obtain a leaching solution;
(iii) adding a mercury-containing material to the solution of step (ii) to start the leaching process; and
(iv) recovering mercury (e.g., using an ion exchange resin);

wherein said thiourea in step (i) is titrated prior to addition to the sulfuric acid solution.

### BRIEF DESCRIPTION OF THE DRAWINGS

FIG. 1 is a graph of gold extraction from copper concentrate using sodium cyanide.

FIG. 2 is a graph of gold extraction from copper concentrate using thiourea and hypochlorite.

FIG. 3 is a graph of thiourea concentration changes with different dosages of bleach solution.

FIG. 4 is a graph of solution oxidation-reduction potential (ORP) changes in different sodium metabisulfite concentrations.

FIG. 5 is a graph of gold extraction from pressure oxidation residue using cyanide.

FIGS. 6A-6D are graphs of gold recovery from pressure oxidation residue using various thiosulfate salts and thiourea.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

As used herein, the term “concentrate” refers to “ore concentrate”. In the mining arts, “ore concentrate”, “dressed ore” or simply “concentrate” is the product generally produced by metal ore mines. The raw ore is usually ground finely in various comminution operations and gangue (waste) is removed, thus concentrating the metal component. Traditionally, the resulting concentrate is then transported to various physical or chemical processes such as hydrometallurgy, pyrometallurgy smelters, and electrometallurgy, and the like, where it is used to produce useful metals. As disclosed herein, the concentrate can be subjected to the methods encompassed by the present invention to obtain various metals.

As used herein, the term “electronic waste” is used interchangeably with “e-waste”. Electronic waste or e-waste describes discarded electrical or electronic devices. Electronic waste or e-waste includes: (1) Temperature exchange equipment (e.g., air conditioners, freezers), (2) Screens, monitors (e.g., TV, laptop), (3) Lamps(e.g., LED lamps), (4) Large equipment (e.g., washing machines, electric stoves), (5) Small equipment (e.g., microwave, electric shaver), and (6) Small IT and telecommunication equipment (e.g., mobile phones, printers).

A further aspect of the present invention pertains to a method of leaching a material, said method comprising:
a) mixing water and sulfuric acid to obtain an aqueous sulfuric acid solution;
b) dissolving thiourea and sodium metabisulfite (“SMB”) in an amount of the solution of step (a);
c) adding the solution of step (b) to the remaining amount of sulfuric acid solution made in step (a);
d) adding a source of hypochlorite to the solution made in step (c) to obtain a leaching solution;
e) adding said material chosen from an ore, a metal-containing material, and a concentrate, to the solution of step (d) to start the leaching process; and
f) recovering metal from step (e);
   wherein said thiourea in the solution of step (b) is titrated prior to addition of the solution of step (b) to step (c).

In some embodiments, the water and sulfuric acid in step (a) may be in a ratio of, for example, about 1:40 (acid:water). In further embodiments, the acid solution in step (a) is the majority of, or main body of, the leaching solution.

In some embodiments, the thiourea and SMB in step (b) may be in a ratio of about 9 to 1 (thiourea: SMB). In some embodiments, the thiourea and SMB may be dissolved in a portion of the acid solution of step (a). In some embodiments, thiourea and SMB may be premixed and dissolved, and the resulting thiourea and SMB solution is then added to the sulfuric acid solution.

In some embodiments, the source of hypochlorite in step (d) may be a hypochlorite solution of about 10% to about 20%.

In some embodiments, the material subjected to leaching may include any of oxide-containing ore, sulfide containing ore, magnetite, black sands, and carbon fines. In further embodiments, the material subjected to leaching, may have a pulp density which ranges from about 10% to about 50%. In some further embodiments, the material subjected to leaching, may have a pulp density which ranges from about 15% to about 25%. The amount of the material subjected to leaching may be varied depending on the grade of precious metal desired (e.g., gold grade) and/or the sulfide concentration.

In some embodiments, the leaching solution may be recovered and recycled or recirculated (or otherwise reused) in the leaching process (e.g., a closed system).

In some embodiments, the recovery of metal in step (f) may be performed with an ion exchange resin.

In some embodiments, the thiourea may be titrated using, for example, a potassium iodate solution (e.g., 0.010 N) and a starch indicator solution (e.g., 0.2%).

In some embodiments, the material subjected to leaching may be ground to reduce particle size of the material to, for example, about 150 mesh to about 200 mesh prior to adding the leaching solution.

In some embodiments, the thiourea concentration may be measured during step (e), by, for example, using a sulfuric acid solution (e.g., about 1 to about 5N, or about 1 to about 3N, or even about 2N) to provide a suitable pH to the thiourea solution being measured (e.g., a pH of about 1 to about 2.5, or even a pH of about 1).

In some embodiments, the pulp density of the material subjected to leaching may be about 15% to about 25%.

In some embodiments, the material subjected to leaching is leached for up to about 1 hour, up to about 2 hours, up to about 3 hours, up to about 4 hours, up to about 5 hours, up to about 6 hours, or even from about 1 hour to about 2 hours.

In some embodiments, the metal recovered is a precious metal, for example, any of gold, silver platinum, palladium, rhodium, and others.

In some embodiments, the metal recovered is gold.

In some embodiments, the metal recovered is a base metal, for example lead, zinc, nickel, arsenic, copper, cobalt, vanadium, tungsten, iron, molybdenum and others.

In some embodiments, said the material subjected to leaching, may be about 30 to about 500 mesh, or even about 150 mesh to about 200 mesh, and may be leached for about 2 hours.

A further aspect of the present invention pertains to a method of leaching a mercury-containing material, said method comprising:
a) mixing water and sulfuric acid to obtain an aqueous sulfuric acid solution;
b) dissolving thiourea and sodium metabisulfite (“SMB”) in an amount of the solution of step (a);
c) adding the solution of step (b) to the remaining amount of sulfuric acid solution made in step (a);
d) adding a source of hypochlorite to the solution made in step (c) to obtain a leaching solution;
e) adding mercury-containing material to the solution of step (d) to start the leaching process.
f) recovering mercury.

In some embodiments, the water and sulfuric acid in step (a) may be in a ratio of, for example, about 1:40 (acid:water). In further embodiments, the acid solution in step (a) is the majority of, or main body of, the leaching solution.

In some embodiments, the thiourea and SMB in step (b) may be in a ratio of about 9 to 1 (thiourea: SMB). In some embodiments, the thiourea and SMB may be dissolved in a portion of the acid solution of step (a). In some embodiments, thiourea and SMB may be premixed and dissolved, and the resulting thiourea and SMB solution is then added to the sulfuric acid solution.

In some embodiments, the source of hypochlorite in step (d) may be a hypochlorite solution of about 10% to about 20%.

In some embodiments, the leaching solution may be recovered and recycled or recirculated (or otherwise reused) in the leaching process (e.g., a closed system).

In some embodiments, the recovery of mercury in step (f) may be performed with an ion exchange resin.

Applications

Leaching of sulfidic, oxide, and mixed ores for gold, silver and platinum group metals (PGMs)

A major advantage of the present invention is that it is not limited to oxide ores for a high rate of extraction. Although cyanide leaching is usually cheaper to run with oxide ores, a thiourea leach system has a distinct advantage over cyanide for ores or concentrates containing precious metals and platinum group metals in both oxide and sulfide form as it can efficiently leach metals from both.

Black Sands Containing Precious Metals

Black sand consists predominantly of magnetite and hematite. The magnetite may sometimes contain very small amounts of nickel, manganese, chromium, and titanium. In some embodiments, the present invention may be used to leach metals from Black sand.

The present invention may be used to recover precious metals from black sand concentrates or black sand tailings. Most black sand placer operations only recover free milling gold which can be recovered by physical separation. Very fine particles of gold, silver and PGMs that cannot be recovered by the conventional process can be recovered with thiourea solution. Precious metals encapsulated in iron and other particulates would be recovered as well. Many black sand tailings or concentrates contain mercury that is presented naturally or from previous attempts to recover precious metals. The present invention can be used to selectively dissolve mercury or any precious metal that is encapsulated in the mercury.

An example of this would be building a plant for sand and gravel companies in precious metal bearing areas that produce black sands.

Magnetite Containing Precious Metals

The present invention may be used to extract precious metals from magnetite ores or concentrates bearing precious metals. Normally magnetite is not a precious metal bearing mineral in the lower 48 states. However, in the Yukon and in parts of Alaska, magnetite often carries precious metals. After precious metals extraction, the magnetite tailings can then be sold as the value of magnetite.

Mercury Recovery in Activated Carbon

The present invention may be used for mercury cleanup. Mercury remains a serious hazard in the mining industry. Although there are no current mercury mines in the U.S., mercury can be naturally present in ore and is produced as a by-product of gold and silver mining. The development and growing use of cyanide technology has increased gold and silver production as well as the recovery of other by-products such as mercury.

There is an urgent need for a way to cleanup of these mine tailings as well as carbon fines. One advantage of the present invention is the method disclosed herein may be used to remove mercury from tailings and other mercury containing ores.

Carbon fines e.g., at the Fort Knox mine contain as much as 0.68 kg/t (20 oz/st) gold. Carbon fines are produced when carbon, which is used in a carbon-in-leach (CIL) or carbon-in-pulp (CIP) process for the recovery of gold, is broken. Typically, these fines, loaded to some extent with gold, exit from a last adsorption stage of the process and are then lost. These carbon fines may also be contaminated with mercury. The method disclosed herein may be used to remove mercury contaminated carbon fines.

For example, removing mercury may include grinding activated carbon to about 150 to about 200 mesh and leaching for about 2 hours. Mercury levels from 1800 ppm may be reduced to 1 ppm. Precious metals, however, are left in the activated carbon. Mercury, arsenic and other metals removed are then captured on ion exchange resin beads and then placed in an environmentally safe form. The removal of mercury from activated carbon is important due to the Mercury Export Ban (MEBA) of 2013 by the US government. Mercury is not to be shipped out of the United States. Precious metal companies in the US have an issue with mercury collected on activated carbon. The method disclosed herein can be used to eliminate the need for roasting carbon and collecting mercury through a retort system.

Mercury in Black Sand and Hard Rock Tailings

Around the world mercury is used and has been used to recover precious metals in most of artisanal miners. Unfortunately, mercury used for recovery is not always recaptured. The present invention can be also used to remove mercury from said tailings as well as recover any precious metals present in oxide or sulfide form.

Cyanide Tailings

The worldwide use of cyanide to recover gold and silver has left a huge environmental problem. It has been witnessed that cyanide tailings in third world countries have been taken directly out of a cyanide vat and placed alongside river and creek banks without being rinsed of the cyanide. This presents a devastating environmental hazard. The present invention is able to treat harmful cyanide tailings and recover any residual precious metals. In addition, with proper grinding the leaching solution can recover precious metal not recovered by cyanide in both oxide and sulfide form. Mercury present in the tailings can also be removed as well.

E-Waste

The present invention may be used to recover precious metals from e-waste with proper grinding and pulp density. For example, the grind size may be less than 75 micron with pulp density ranging from about 1% to about 40%. Leaching for this type of material has been limited to recovering as much precious metal as possible without leaching the base metals that are present. Base metal tailings would be rinsed and then sold as a byproduct ore leached by a conventional acid leaching.

E-Waste Such as Pins, Plugs, Sensors and the Like that are Plated

Electronic waste of this type is difficult to grind due to the nature of the product. In this scenario, the material is placed in a container or bath so that thiourea can flow over the plated material. Once the precious metal plating is stripped, the remaining base metal can be sold as a scrap. Usually, this type of material is otherwise sent overseas to remove the plated precious metal by using a cheap labor.

Catalytic Converters

The present invention can be used to recover precious metals found in catalytic converters. The material must be ground properly. Oftentimes the material needs to be roasted first to remove carbon and lead before leaching.

Catalysts Containing Precious Metals

The present invention may be used to capture precious metals used in industrial catalysts. For this to occur, the material must be properly ground.

Carbonaceous Ores

The present invention may be used to leach gold and other precious metals from carbonaceous ores. Gold thiourea complex usually adsorbs onto activated carbon but chlorine (generated from hypochlorite oxidant used during the leaching process as encompassed by the present invention) breaks down the carbonaceous materials resulting in no preg-robbing.

Superfund Cleanup Sites

The present invention because of its ability to remove certain base metals along with precious metals can be used for some superfund sites. An example of this type of environmental cleanup is the Iron King superfund site in Humboldt AZ. The inventors surprisingly found that during brief testing of the Iron King tailings (2 hours), 95% of precious metals can be recovered while lowering lead, zinc and arsenic levels.

Base Metal Recovery

The present invention may be used to recover base metals (e.g., lead, zinc, nickel, arsenic, copper, cobalt, vanadium, tungsten, iron, molybdenum and others).

The present invention may also be used to remove arsenic, antimony, and other toxic metals from copper concentrates. The ‘clean’ copper concentrate can then be processed in a smelter, without environmental problems and penalties due to those elements.

For gold-bearing copper concentrate, direct gold extraction from the concentrate can be implemented prior to smelting process resulting in increased revenues compared to the precious metal credits from the smelters. Another advantage is to make cleaner copper concentrate if it contains higher arsenic. Preliminary tests showed that the arsenic dissolution was high enough during the gold leaching to decrease the arsenic content in the leached residue with majority of copper sulfides remained in the solid form.

Most metals and transition metals, and rare earth metals that can dissolve in acidic solution can be extracted using the present invention.

### LIST OF EMBODIMENTS

1. A method of leaching an ore, or a metal-containing material or a concentrate, comprising:
a) Mixing water (e.g., DI water) and sulfuric acid (e.g., 98% sulfuric acid may be used; the acid may be in a ratio of about 1:40 sulfuric acid:water) to obtain an aqueous sulfuric acid solution. In some embodiments, the acid solution is the main body of the leaching solution.
b) Dissolving thiourea and sodium metabisulfite (“SMB”) (e.g., in a ratio of about 9 to about 1 of thiourea and SMB) the solution of step (a). For example, thiourea and SMB may be dissolved in a portion of the solution of step (a). In some embodiments, thiourea and SMB may be pre-mixed and dissolved. The thiourea and SMB solution is then added to the sulfuric acid solution. This may eliminate steps (b) and (c).
c) Adding the solution of step (b) to the remaining amount of sulfuric acid solution made in step (a);
d) Adding a source of hypochlorite (such as a hypochlorite solution with a concentration of about 10 to about 20%) to the solution to step (c) to obtain a leaching solution;
e) Adding said ore, or said concentrate, or said metal-containing material (e.g., oxide-containing ore, sulfide containing ore, magnetite, black sands, carbon fines) to the solution of step (d) to start the leaching process. In some embodiments, the ores or the concentrate or the metal-containing material may have a pulp density which ranges from about 10 to about 50%. In further embodiments, the ores or the concentrate or the metal-containing material may have a pulp density which ranges from about 15 to about 25%. The amount of ores/concentrates can be varied depending on the precious metal grade (e.g., gold grade) and sulfide concentration. In some embodiments, the solution of step (a) is recycled or recirculated (or otherwise reused) in the leaching process, in e.g., a closed system.
f) Recover metal from step (e) (e.g., using an Ion Exchange Resin).

wherein said thiourea solution of step (b) is titrated (using e.g., potassium iodate solution (e.g., 0.010N) and e.g., a starch solution is used as an indicator (e.g., 0.2%)) prior to addition of the solution of step(b) to step (c);

optionally, wherein said ore or said material is grounded to reduce the particle size of said ore or said material (e.g., to about 150 to about 200 mesh) prior to adding the leaching solution of step (d); and

optionally, wherein thiourea concentration is monitored during step (e), and optionally wherein sulfuric acid solution (e.g., about 1 to about 5N or about 1 to about 3N, or about 2N) is used to provide enough acidity (e.g., pH is about 1 or pH is about 1 to about 2.5) to the thiourea solution being measured.

2. The method of embodiment 1, wherein pulp density of the ore or material is about 15 to about 25%.

3. The method of embodiment 1, wherein the ore or the material or the concentrate is leached for up to about 6 hours.

4. The method of embodiment 1, wherein said metal is a precious metal (e.g., gold, silver, platinum, palladium, and rhodium).

5. The method of embodiment 1, wherein said metal is a base metal (e.g., tungsten, molybdenum, arsenic, and copper).

5. The method of embodiment 4, wherein said metal is gold.

6. A method of leaching mercury from mercury containing materials (e.g., cyanide tailing and mercury-containing tailings) comprising
a) Mixing water (e.g., DI water) and sulfuric acid (e.g., 98% sulfuric acid may be used; the acid may be in a ratio of about 1:40 sulfuric acid:water). In some embodiments, this solution is the main body of the leaching solution.
b) Dissolving thiourea and SMB (e.g. in a ratio of about 9 to about 1 of thiourea and SMB) in an amount of the solution of step (a) to have total dissolution thiourea and SMB. The thiourea and SMB solution is then added to the sulfuric acid solution. This may eliminate steps b and c.
c) Adding the solution of step (b) to the remaining amount of sulfuric acid solution made in step (a);
d) Adding a source of hypochlorite (such as bleach solution or commercial hypochlorite with 14% concentration) to the solution to step (c) to obtain a leaching solution;
e) Adding mercury containing material (e.g., cyanide tailing, contaminated black sands, mercury-containing tailings, carbon fines or activated carbon, Black Sand and Hard Rock tailing) to the solution of step (d) to start the leaching process;
f) Recovering mercury (using e.g., using an ion exchange resin).

7. The method of embodiment 1 or embodiment 6, wherein the ore/concentrate is leached for up to about 2 hours.

8. The method of embodiment 1, wherein the ore/concentrate is leached for up about 1 to about 2 hours.

9. The method of embodiment 1, wherein the ore/concentrate is leached for up to about 4 hours.

10. The method of embodiment 1, wherein said ore or said material is ground to 30 to 500 mesh and leached for about 2 hours.

11. The method of embodiment 10, wherein said ore or said material is ground to 150 to 200 mesh.

12. The method of embodiment 6, wherein the mercury containing material is leached for up to about 2 hours.

### EXAMPLES

It is to be understood that both the foregoing general description of the invention and the following detailed description are exemplary, and thus do not restrict the scope of the invention.

### Example 1: Use of Thiourea and Hypochlorite

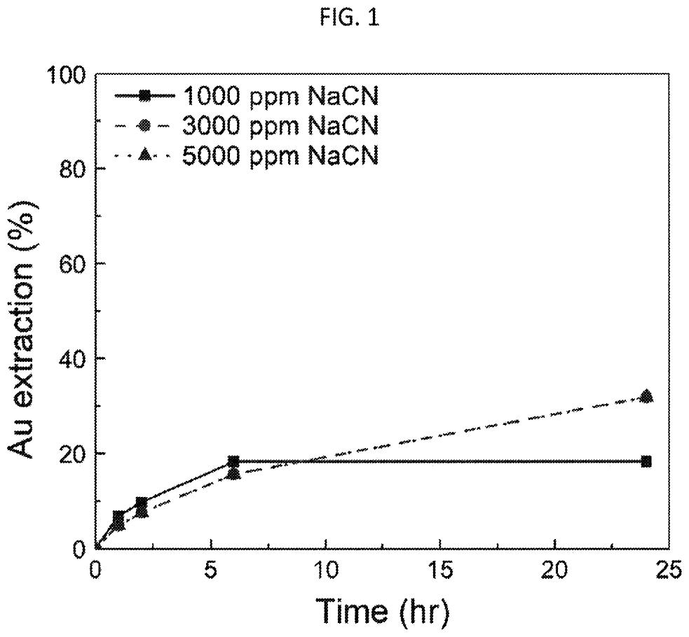

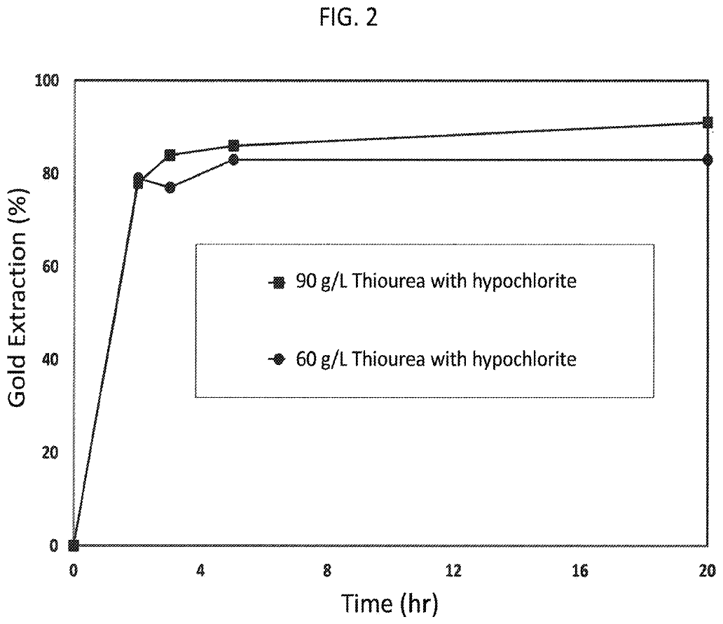

One example is shown in FIG. 1 and FIG. 2, demonstrating that the gold extraction from a copper concentrate containing about 14 grams per metric ton (g/t) of gold and 20 wt % of copper. As shown in FIG. 1, the gold extractions using cyanide were lower than wt % of the total amount of gold in the copper concentrate even with 5,000 ppm of sodium cyanide which is a very high concentration. FIG. 2 shows the gold extraction from the sulfidic copper concentrate using thiourea solution, reaching over 95 wt % with 90 g/L thiourea. Other test results (not shown here) were observed with 99 wt % gold extraction in an optimized condition.

The leached residues still containing high copper content can be further processed by hydrometallurgical process or shipped to a smelter to produce a pure copper cathode.

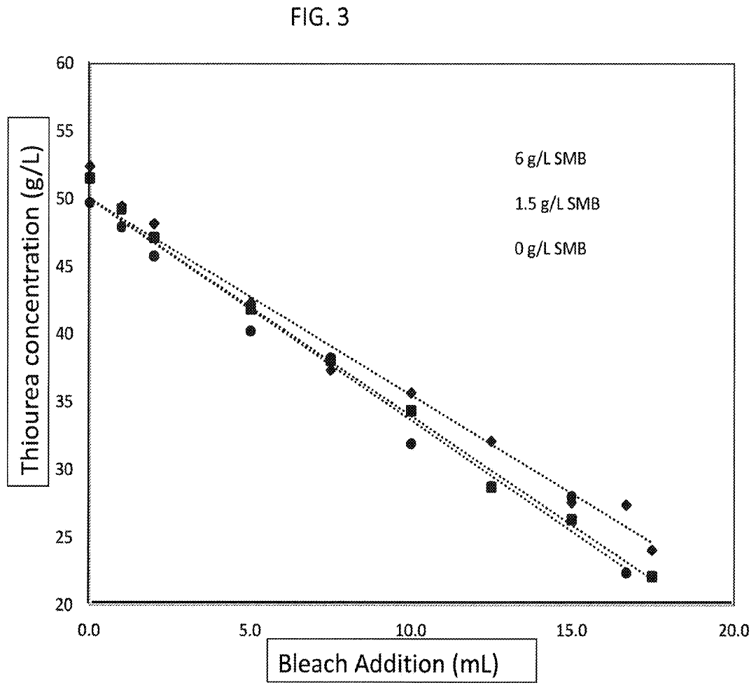

Bleach solution was used as a source of hypochlorite. As shown in FIG. 3, the thiourea concentration plummeted with increased bleach solution volume. The titration of thiourea in the leach solution was developed to accurately measure and monitor thiourea concentration during the leaching process.

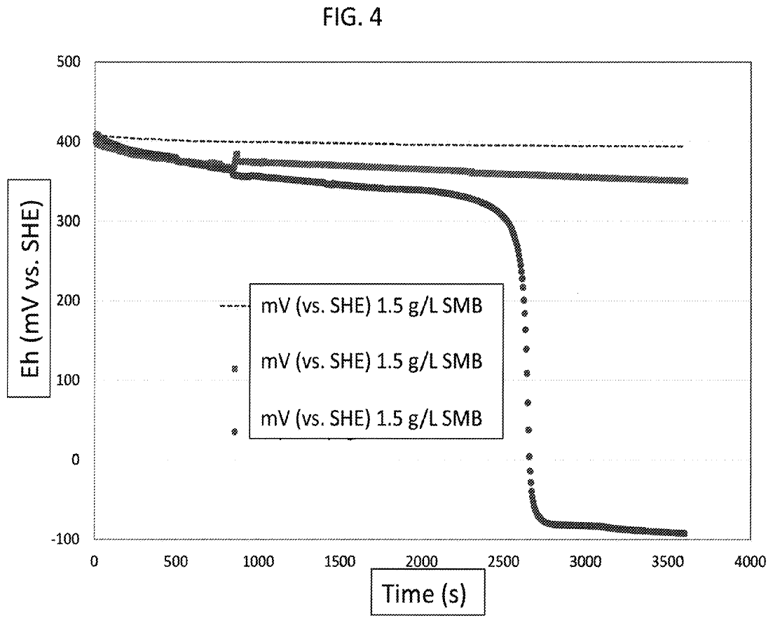

The sodium metabisulfite (SMB) also played another key role for maintaining solution oxidation-reduction potential (ORP). Without SMB, the solution ORP decreased from 300s to below 0 V (vs. SHE) in 45 minutes. Under 200 mV, gold was not observed to be extracted from the sulfidic ores. The SMB and its concentration control were very important to keep the reaction continuing. On the other hand, when 6 g/L SMB was used as seen in FIG. 4, 1.5 g/L SMB worked better than the condition of 6 g/L SMB.

### Example 2

Materials

Tables 1 and 2 show the chemical analysis of the copper concentrate used for experiments shown in FIG. 1 and FIG. 2 by ICP-OES following acid digestion, and mineralogical analysis using XRD. The main copper sulfide mineral was chalcopyrite and a small amount of chalcocite. The particle size of the concentrate was analyzed to be P₈₀ 30 μm by particle size analyzer. The gold grade was 14.41 g/t.

TABLE 1
Chemical analysis of copper concentrate/%

| Au/(g/t) | CU | Fe | S | Si |
|---|---|---|---|---|
| 14.41 | 20.3 | 25.97 | 30.9 | 5.38 |
| Ca | K | Mg | Zn | Na |
| 1.16 | 0.97 | 0.64 | 0.53 | 0.23 |

TABLE 2
Mineralogy analysis of copper concentrate/%

| | | | | | | Muscovite | |
|---|---|---|---|---|---|---|---|
| Chalcopyrite | Pyrite | Bornite | Covellite | Plagioclase | K-Feldspar | Grou | Quartz |
| 39 | 26.9 | 6.9 | 3.6 | 7.3 | 4.6 | 5.7 | 4.2 |

A pressure oxidation (POX) residue after gold-bearing copper concentrate pre-treated by pressure oxidation was collected and tested for gold leaching. Table 3 shows the chemical analysis of the sample. The copper content was 0.24%, and the gold grade was 2.90 g/t. The mineral analysis is presented in Table 4. Hematite was the main mineral phase in the residue, basic iron sulphate (Fe(SO4)OH) also existed, accounting for 25.2%. Jarosite was also detected with a level of 5.5%.

TABLE 3
Chemical analysis of POX residue/%

| Au/(g/t) | Cu | Fe | Si | Mo | Al | Mg | K |
|---|---|---|---|---|---|---|---|
| 2.90 | 0.24 | 37.60 | 5.09 | 1.542 | 1.01 | 0.24 | 0.56 |

TABLE 4
Mineralogy analysis of POX residue/%

| Hematite | Fe(SO₄)(OH) | Jarosite | Quartz | K-Feldspar | Muscovite | Butlerite | Bal. |
|---|---|---|---|---|---|---|---|
| 41.0 | 25.2 | 5.5 | 8.2 | 7.1 | 4.1 | 5.2 | 3.7 |

### Experimental Method

Leaching tests were conducted by bottle roll tests at room temperature and ambient pressure for 24 hours. A 2.5 L Winchester bottle was used uncapped, and it was agitated by a roller at 40 rpm. Pulp density was 25% with 100 g solid ore sample and 300 g solution. Around 10 ml kinetics samples were taken at 1, 2, 6, and 24 hours for gold assay, and pH and Eh were also recorded at the same time. During the test, the lixiviant concentration was titrated and additional lixiviant was added to maintain the initial concentration. Pulp pH was adjusted to the target pH value by adding relevant hydroxides. The gold extraction was calculated based on the head gold grade (as shown in Table 1 and Table 3) and solution gold assay by atomic absorption spectroscopy (AAS).

Cyanide, thiourea and thiosulfates (including Na−, (NH4)−, and Ca−) were tested to extract gold from the two samples. Lime was used to control pH at 11 during cyanidation. In thiourea leaching solution, the pH was set to 1.5 with 0.3 M H2SO4. To simplify the leaching solution chemistry of thiosulfate, pH was controlled by hydroxides with the same cation as thiosulfate. The detailed information is listed in Table 5.

TABLE 5
Lixiviants and experimental conditions in the test

| Lixiviant | Formula | pH control agent | Target pH |
|---|---|---|---|
| Sodium cyanide | NaCN | Ca(OH)₂ | 11.0 |
| Thiourea | CS(NH₂)₂ | H₂SO₄ | 1.5 |
| Sodium thiosulfate | Na₂S₂O₃ | NaOH | 10.0 |
| Ammonium thiosulfate | (NH₄)₂S₂O₃ | NH₃ · H₂O | 10.0 |
| Calcium thiosulfate | CaS₂O₃ | Ca(OH)₂ | 10.0 |

Gold Leaching from the Copper Concentrate

Gold extraction from the copper concentrate using cyanide is shown in FIG. 1. As can be seen, the gold recovery at 24 hrs increased from 18% to 32% when the cyanide concentration increased from 1000 ppm to 3000 ppm, but no further increase of gold recovery was observed with 5000 ppm NaCN, suggesting that not all the gold was cyanide soluble and it may have been locked in the sulfide mineral matrix.

Gold recovery after 20 hrs using thiourea as lixiviant is shown in FIG. 2. The gold extractions using thiourea system in a specially synthesized solution showed 82% and 92% in 60 g/L thiourea and 90 g/L thiourea, respectively.

Gold Leaching from POX Residue

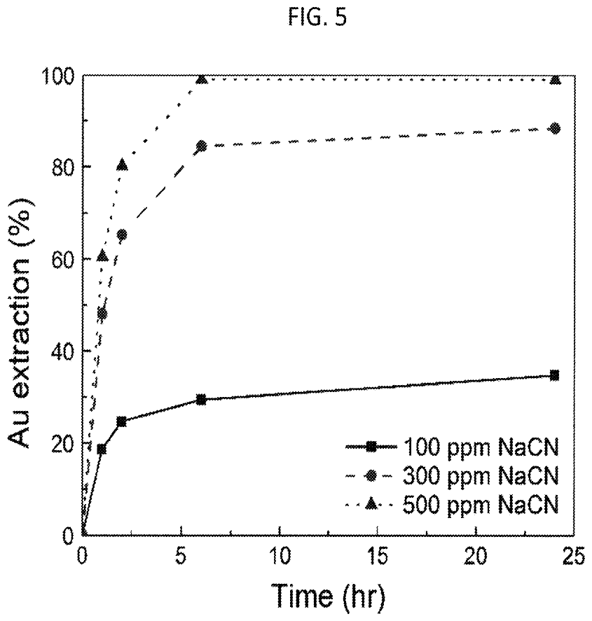

The results of POX residues leached by cyanide are given in FIG. 5. The gold recovery after 24 hrs showed an increasing trend with sodium cyanide concentration. The gold extraction was 35% with 100 ppm NaCN, and it increased up to 99% with 500 ppm NaCN, indicating the copper in the sample consumed cyanide during the gold leaching. The initial gold leaching rate was also increased with increasing cyanide concentration as seen in FIG. 3. There was a big increase between 100 ppm NaCN and 300 ppm NaCN especially in two hours. A small increase was also observed from 300 ppm NaCN and 500 ppm NaCN.

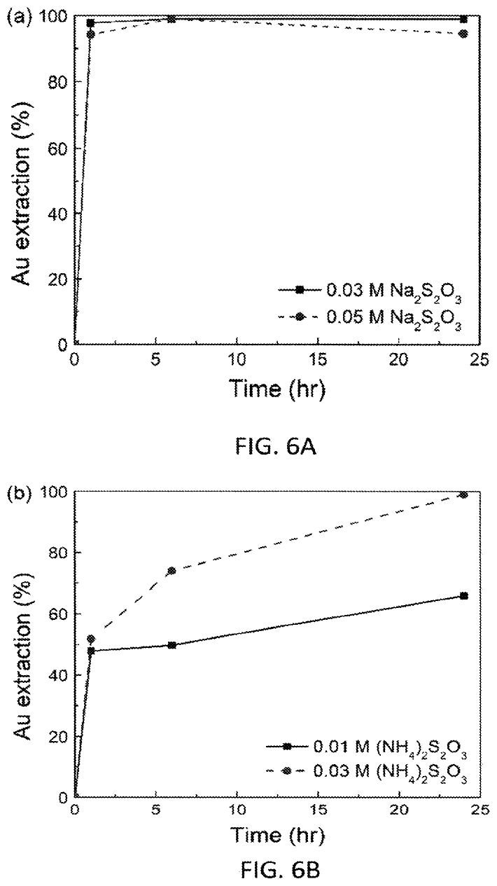

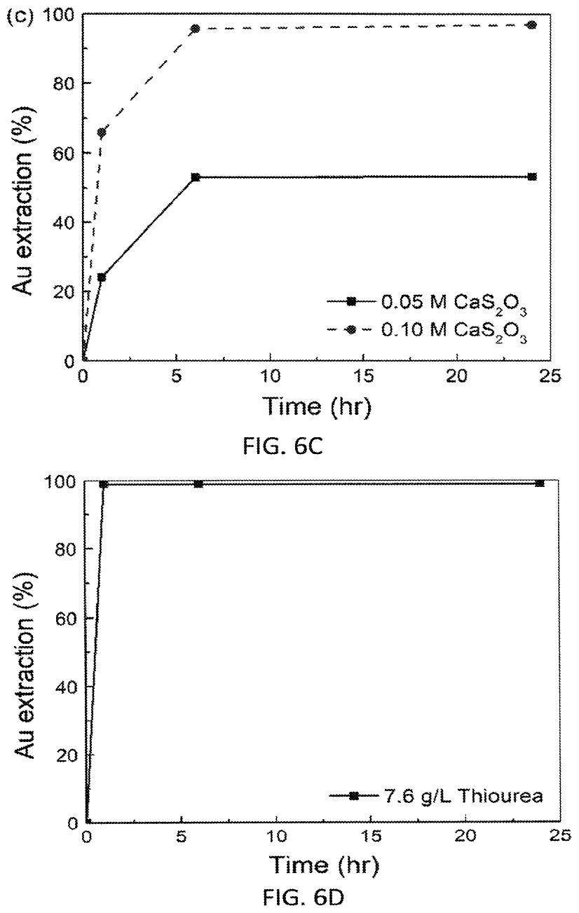

The gold recoveries from the POX residue using various thiosulfate salts and thiourea are shown in FIGS. 6A-6D.

As shown in FIG. 6A, when using sodium thiosulfate as lixiviant, the gold was easily extracted with 0.03 M to obtain 99% gold recovery.

For ammonium thiosulfate, the gold recovery increased with ammonium thiosulfate concentration in the solution (see FIG. 6B). The lower gold recovery with 0.01 M (NH4)25203 might be explained by the consumption of thiosulfate by copper ion in the solution. In this test, ammonium hydroxide was used as pH control agent, and thus over 150 ppm copper ion was dissolved and forms various copper-ammonia complex. It has been reported that thiosulfate may be oxidized by excessive copper ion (Xu et al., 2017).

In calcium thiosulfate leaching solution, gold extraction also increased with higher CaS2O3 concentration (see FIG. 6C). The gold recovery was 97% with 0.10 M CaS2O3 when using lime to control pH.

Thiourea also worked as an effective lixiviant for the POX residue and gold recovery of 99% was observed with 7.6 g/L thiourea (see FIG. 6D). The initial iron concentration was 5 g/L in the solution, and it was from the dissolution of iron in the ore sample. Under acidic conditions, the basic iron sulphate from the POX residue was dissolved and generated ferric ions. The dissolved ferric ions helped to oxidize gold and no additional ferric ion was needed to leach this POX residue in thiourea solution.

All publications mentioned herein are incorporated by reference to the extent they support the present invention.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.

1. A method of leaching a material, comprising:
a) mixing water and sulfuric acid to obtain an aqueous sulfuric acid solution;
b) dissolving thiourea and sodium metabisulfite in an amount of the solution of step (a);
c) adding the solution of step (b) to the remaining amount of sulfuric acid solution made in step (a);
d) adding a source of hypochlorite to the solution made in step (c) to obtain a leaching solution;
e) adding a material chosen from an ore, a metal-containing material, and a concentrate, to the solution of step (d) to start the leaching process; and
f) recovering metal;
wherein said thiourea in the solution of step (b) is titrated prior to addition of the solution of step(b) to step (c);
optionally, wherein said ore or said material grounded to reduce the particle size of said material prior to adding said material the leaching solution of step (d); and
optionally, wherein concentration of said thiourea is monitored during step (e).

2. The method of claim 1, wherein said material has a pulp density in the range of about 15 to about 25%.

3. The method of claim 1, wherein said material is leached for up to about 6 hours.

4. The method of claim 1, wherein said metal is a precious metal.

5. The method of claim 1, wherein said metal is a base metal.

6. The method of claim 1, wherein said metal is gold.

7. A method of leaching mercury from mercury-containing material, said method comprising
a) mixing water and sulfuric acid to obtain an aqueous sulfuric acid solution;
b) dissolving thiourea and sodium metabisulfite in an amount of the solution of step (a) to have total dissolution thiourea and sodium metabisulfite.
c) adding the solution of step (b) to the remaining amount of acid solution made in step (a);
d) adding a source of hypochlorite to the solution to step (c) to obtain a leaching solution;
e) adding mercury-containing material to the solution of step (d) to start the leaching process;
f) recovering mercury using an ion exchange resin.

8. The method of claim 1, wherein the ore, or metal-containing material or concentrate is leached for up to about 4 hours.

9. The method of claim 1, wherein said material is ground to about 30 to about 500 mesh and leached for about 2 hours.

10. The method of claim 1, wherein said material to is ground to about 150 to about 200 mesh.

11. The method of claim 7, wherein the mercury-containing material is leached for up to about 2 hours.

12. The method of claim 1, wherein said material is an oxide-containing ore, a sulfide containing ore, magnetite, black sands, electronic waste, a catalytic converter, or carbon fines.

13. The method of claim 1, wherein said source of hypochlorite is a bleach solution or commercial hypochlorite with about 14% concentration.

14. The method of claim 1, wherein said thiourea and said SMB are in a ratio of about 9 to about 1 of thiourea.

15. The method of claim 1, wherein said step (f) comprises recovering metal using an ion exchange resin.

16. The method of claim 7, wherein said mercury-containing material is cyanide tailings, contaminated black sands, mercury-containing tailings, carbon fines, activated carbon, Black Sand or Hard Rock tailing.

17. The method of claim 7, wherein said thiourea and said SMB are in a ratio of about 9 to about 1 of thiourea.

18. The method of claim 7, wherein said source of hypochlorite is a bleach solution or commercial hypochlorite with about 14% concentration.

19. A method of leaching a material, said method comprising:
(i) preparing a solution by premixing and dissolving thiourea and SMB and adding the resulting thiourea/SMB solution to an aqueous sulfuric acid solution;
(ii) adding a source of hypochlorite to the solution made in step (i) to obtain a leaching solution;
(iii) adding said material chosen from an ore, a concentrate, and a metal-containing material, to the solution of step (ii) to start the leaching process; and
(iv) recovering metal (e.g., using an ion exchange resin);
wherein said thiourea in step (i) is titrated prior to addition to the sulfuric acid solution.
